(19) United States
(12) Patent Application Publication
(10) Pub. No.: US 2023/0008708 A1
(43) Pub. Date: Jan. 12, 2023

(54) HIGHLY HEAT RECIRCULATING MULTIPLEXED REACTORS

(71) Applicant: U.S. Army DEVCOM, Army Research Laboratory, Adelphi, MD (US)

(72) Inventors: Sunny V. Karnani, West Lafayette, IN (US); Christopher M. Waits, Edgewater, MD (US)

(21) Appl. No.: 17/369,999

(22) Filed: Jul. 8, 2021

(51) Int. Cl. F23C 3/00; F23C 13/00; B01J 19/00

(52) U.S. Cl. CPC F23C 3/002; F23C 13/00; B01J 19/0093; F23C 2900/03001; F23C 2900/03009; B01J 2219/00797; B01J 2219/00822; B01J 2219/00873

(57) ABSTRACT

A recirculating micro-combustor device and a method of formation includes an array of reactors contacting each other. Each reactor includes a front wall; an end wall oppositely positioned to the front wall; a pair of edge walls connecting the front wall to the end wall; an inlet port positioned in the front wall; a pair of outlet ports positioned in the front wall; and a combustion chamber connected to the inlet port and positioned between the front wall and the end wall. The combustion chamber includes a pair of inner walls defining a first area to accommodate a chemical combustion therein, and a pair of second areas to accommodate an exhaust of a reaction of the chemical combustion. The pair of second areas connect to the pair of outlet ports. Adjacent edge walls of adjacent reactors directly contact each other to form the array of reactors.

### GOVERNMENT INTEREST

The embodiments herein may be manufactured, used, and/or licensed by or for the United States Government without the payment of royalties thereon.

### BACKGROUND

### Technical Field

The embodiments herein generally relate to heat exchanger, and more particularly to combustion reactors for power generation.

### Description of the Related Art

The overarching application of heat exchangers is generated via combustion and delivered to a converter (e.g., thermoelectric, thermophotovoltaic, thermionic, Stirling, or other externally driven heat engine) with efficiency, size, and weight that are feasible for a particular use case (e.g., portable power generation). Currently, high temperature, high heat flux solid state electricity generators using combustion-based heat sources are insufficiently efficient to be commercially viable. The ability to control the heat path is critical in determining the conversion efficiency. In the conventional cases, the heat will flow to active areas (i.e., where it is desired for the heat path to go) for conversion or be lost through insulating regions (i.e., where it is desired to minimize heat loss) and as sensible heat out of the exhaust (i.e., where it is desired to minimize heat loss). Additionally, within the active areas there may be specific heat transfer mechanisms desired based on the converter approach, for example, radiant heat transfer only is desired using thermophotovoltaic conversion approaches.

Some conventional solutions to reduce non-radiant heat loss in thermophotovoltaic converter active areas include a series of rectangular micro-combustors, planar emitters, filters, and photovoltaic (PV) cells. A vacuum gap between the emitters and cells is introduced to limit convective heat losses. Other conventional approaches attempt to refine the surface area ratio of the device leading to taking emissions from the sidewalls of the device or to utilize multilayer insulators (MLI) between the components to reduce heat loss from insulating regions. Still other conventional solutions involve routing cold air for recirculation to reduce heat loss from insulating regions, which provides for a more directly integrated recuperator. These solutions are distinguishable over a single cylindrical design by simplifying fabrication and assembly of the system, allowing for the easy integration of a recuperator, and permitting enhanced scalability as the number of modular-thermophotovoltaic units can be increased according to the application's power requirements and geometrical configurations.

Some conventional designs to deliver heat to the active region focus on routing the high temperature combustion products through a heat exchanger downstream of a combustion zone to deliver the heat to a converters active area. Some conventional designs couple to the active area more directly to the high temperature combustion zone to take heat from radiation or conduction mechanisms.

Accordingly, microchannel heat exchangers without reactions have been developed in academia and in industry. These systems generally involve larger tube-in-tube configurations used in gas-fired radiant tubes for heating applications or chemical conversion processes. Heat recirculation is critical for proper combustion, and heat recirculation via wall conduction is one approach and is only explored via single reactors, while microchannel heat exchangers have optimized the surface area to volume ratio proving to greatly increase the heat exchanger effectiveness. Porous combustion is another approach, which is a cross-over from single channel to multi-channel combustion, but with little control. Therefore, there remains a need to develop a high efficiency reactor for small scale power generation that minimizes heat loss from both exhaust and insulating regions.

### SUMMARY

In view of the foregoing, an embodiment herein provides a recirculating micro-combustor device comprising an array of reactors contacting each other, wherein each reactor comprises a front wall; an end wall oppositely positioned to the front wall; a pair of edge walls connecting the front wall to the end wall; an inlet port positioned in the front wall; a pair of outlet ports positioned in the front wall; and a combustion chamber connected to the inlet port and positioned between the front wall and the end wall, wherein the combustion chamber comprises a pair of inner walls defining a first area to accommodate a chemical combustion therein, and a pair of second areas to accommodate an exhaust of a reaction of the chemical combustion, and wherein the pair of second areas connect to the pair of outlet ports, wherein adjacent edge walls of adjacent reactors directly contact each other to form the array of reactors.

The pair of inner walls of the combustion chamber may extend from the front wall in a cantilever configuration without contacting the end wall. An energy loss through the adjacent edge walls is less than an energy loss through the end wall. The first area is to accommodate a mixture of fuel and air through the inlet port into the combustion chamber. The array of reactors comprises a x×y arrangement of rows and columns of the adjacent reactors, and wherein x and y are positive integers. In an example, x and y are equal. In another example, x and y are unequal. The array of reactors may be arranged in a square configuration. The heat transfer between the adjacent reactors is controlled by a temperature difference between the adjacent reactors. The reactor may comprise any of silicon carbide, tungsten, and a nickel-chromium-iron alloy.

Another embodiment provides a method of forming a recirculating micro-combustor device, the method comprising forming a plurality of reactors, wherein each reactor is formed by providing a front wall; positioning an end wall opposite to the front wall; connecting a pair of edge walls from the front wall to the end wall; positioning an inlet port in the front wall; positioning a plurality of outlet ports in the front wall; and creating a combustion chamber connected to the inlet port and positioned between the front wall and the end wall, wherein the combustion chamber comprises a pair of inner walls defining a first area to accommodate a chemical combustion therein, and a plurality of second areas to accommodate an exhaust of a reaction of the chemical combustion, and wherein the plurality of second areas connect to the plurality of outlet ports. The method further comprises arranging the plurality of reactors into an array of reactors contacting each other, wherein adjacent reactors share a second area of the plurality of second areas.

The method may further comprise extending the pair of inner walls of the combustion chamber from the front wall in a cantilever configuration without contacting the end wall. The array of reactors is configured to have an energy loss through adjacent edge walls to be less than an energy loss through the end wall. The first area is configured to accommodate a mixture of fuel and air through the inlet port into the combustion chamber. The array of reactors is configured to comprise a x×y arrangement of rows and columns of the adjacent reactors, and wherein x and y are positive integers. In an example, x and y are equal. In another example, x and y are unequal. The array of reactors may be arranged in a square configuration. The array of reactors is configured to have a heat transfer between the adjacent reactors to be controlled by a temperature difference between the adjacent reactors. Each reactor may comprise any of silicon carbide, tungsten, and a nickel-chromium-iron alloy.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a graphical representation illustrating the energy lost via radiation in a thermal power generation system;

FIG. 2A is a schematic diagram of a recirculating micro-combustor device, according to an embodiment herein;

FIG. 2B is a schematic diagram of another recirculating micro-combustor device, according to an embodiment herein;

FIG. 3A is a schematic diagram illustrating an array of reactors of the micro-combustor device of FIG. 2A, according to an embodiment herein;

FIG. 3B is a schematic diagram illustrating another array of reactors of the micro-combustor device of FIG. 2A, according to an embodiment herein;

FIG. 4A is a graphical representation illustrating the non-premixed centerline temperature at two side wall boundary conditions as a function of input power, according to an embodiment herein;

FIG. 4B is a graphical representation illustrating the non-premixed thermal efficiency at two side wall boundary conditions as a function of input power, according to an embodiment herein;

FIG. 5A is a graphical representation illustrating the premixed centerline temperature at two side wall boundary conditions as a function of input power, according to an embodiment herein;

FIG. 5B is a graphical representation illustrating the premixed thermal efficiency at two side wall boundary conditions as a function of input power, according to an embodiment herein;

FIG. 6A is a flow diagram illustrating a method of forming a recirculating micro-combustor device, according to an embodiment herein; and

FIG. 6B is a flow diagram illustrating a method of forming each reactor of a multi-reactor micro-combustor device, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

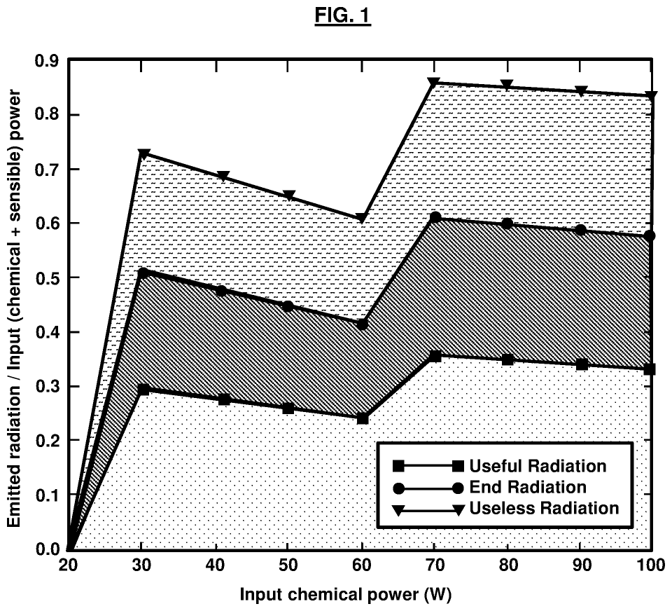

As mentioned above, high temperature, high heat flux solid state electricity generators of the conventional solutions are insufficiently efficient to be commercially viable. The embodiments herein address this issue by limiting heat loss through non-useful surfaces by multiplexing. More particularly, the embodiments herein provide a solution to address parasitic losses in hydrocarbon-fueled chemical reactors by creating near adiabatic peripheral walls. Adiabatic walls are realized by arraying a number of identical, highly heat recirculating concentric tube-in-tube reactors. By coupling the end face of the reactor array to a suitable thermal converter (e.g., thermoelectric, thermophotovoltaic, or thermionic), an entire class of silent, efficient, and portable generators becomes possible. The embodiments herein provide a 2D reactor array with integrated heat recuperation where heat is extracted from the endcap of the reactor. Referring now to the drawings, and more particularly to FIGS. 1 through 6B, where similar reference characters denote corresponding features consistently throughout the figures, there are shown preferred embodiments. In the drawings, the size and relative sizes of components, layers, and regions, etc. may be exaggerated for clarity.

Heat loss pathways in a chemical reactor can be broken down into four categories or pathways: (1) Thermal energy transferred to a desired surface; (2) Thermal energy transferred lost radiatively or by convection from non-desirable surfaces; (3) Thermal energy transferred to non-desirable surfaces lost via conduction; or (4) Sensible thermal energy exhausted from the system. Pathways (2), (3), and (4) are parasitic. As such, parasitic losses tend to reduce the temperature differentials and overall thermal efficiencies in the system, which may be defined as the fraction of energy introduced to the system that is available for conversion on a desirable surface. FIG. 1 shows the energy lost via radiation, which the embodiments herein overcome.

The embodiments herein minimize heat losses from Pathway (2) by placing identical reactors next to and in contact with each another, while still allowing heat loss from a designated target surface (Pathway (1)). The insulation provided by multiplexing improves as the number of arrayed reactors increases. This limits the relative number of external reactor walls subject to heat losses via Pathway (2).

The principal reactor (“pixel”) to be arrayed is designed so as to limit the window of ignition to just prior of the reactor's turnaround region. This places restrictions on the geometry, materials, and chemical power throughput in a candidate system, in addition to the requirements of the desired application. Accordingly, the embodiments herein overcome this design challenge by providing multiplexed reactors as thermal converters to reduce parasitic heat loss. The solution provided by the embodiments herein offers a significant advance over the conventional solutions as the sensitive coupling between heat transfer and temperature-dependent chemical kinetics in confined channels is a challenge that has to be overcome.

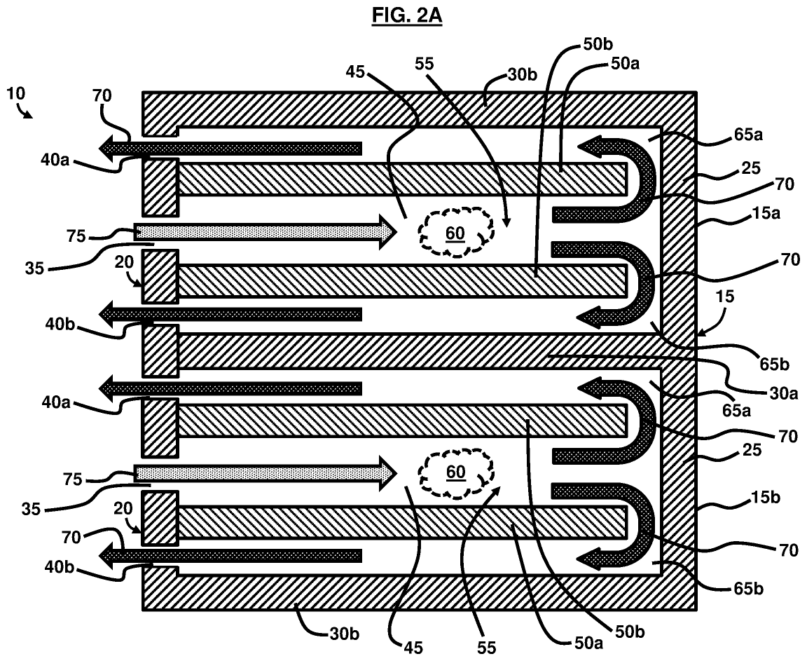

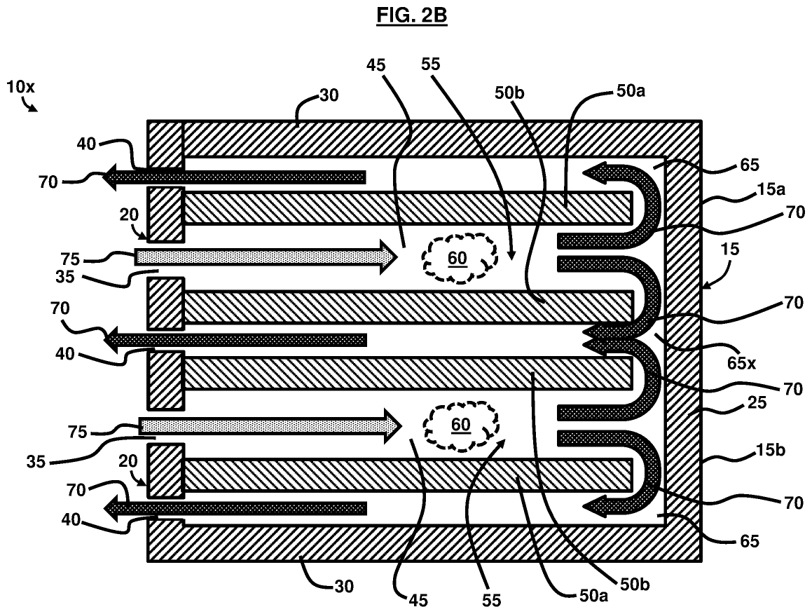

FIG. 2A, with reference to FIG. 1, is a schematic diagram illustrating a catalytic or non-catalytic recirculating micro-combustor device 10 comprising an array of reactors 15 contacting each other. The various components of the reactor 15 may comprise any of silicon carbide, tungsten, a nickel-chromium-iron alloy, and ceramics. However, other materials such as high temperature metals, alloys, and superalloys may be utilized, and the embodiments herein are not restricted to a particular type of material. Moreover, the selection of the materials may be dependent on the temperatures resulting from the fuel and fuel flow rate, according to an example. Each reactor 15a, 15b comprises a front wall 20, an end wall 25 oppositely positioned to the front wall 20, a pair of edge walls 30a, 30b connecting the front wall 20 to the end wall 25, an inlet port 35 positioned in the front wall 20, a pair of outlet ports 40a, 40b positioned in the front wall 20, and a combustion chamber 45 connected to the inlet port 35 and positioned between the front wall 20 and the end wall 25. In an example, the width of each of the front wall 20, end wall 25, and pair of edge walls 30a, 30b may be approximately 1 mm, although other widths are possible. In an example, the length and width of the array of reactors 15 may be approximately 20 mm×10 mm, although other lengths and widths are possible. The inlet port 35 may connect to an air preheat system (not shown) to heat the air (e.g., at 160° C., for example) entering the combustion chamber 45 through the inlet port 35.

The combustion chamber 45 comprises a pair of inner walls 50a, 50b defining a first area 55 to accommodate a chemical combustion 60 therein. In an example, the width of the combustion chamber 45 may be approximately 1 mm, although other widths are possible. The pair of inner walls 50a, 50b of the combustion chamber 45 may extend from the front wall 20 in a cantilever configuration without contacting the end wall 25 thereby allowing the exhaust 70 to continue along the pair of second areas 65a, 65b and out through the pair of outlet ports 40a, 40b. In an example, the width of each of the pair of inner walls 50a, 50b may be approximately 0.5 mm, although other widths are possible. Moreover, the first area 55 is to accommodate a mixture 75 of fuel (e.g., CₓH_{y} compounds, for example) and air through the inlet port 35 into the combustion chamber 45. The combustion chamber 45 further comprises a pair of second areas 65a, 65b to accommodate an exhaust 70 of a reaction of the chemical combustion 60. The pair of second areas 65a, 65b connect to the pair of outlet ports 40a, 40b. In an example, the width of each of the pair of second areas 65a, 65b between the pair of inner walls 50a, 50b and each of the edge walls 30b may be approximately 0.5 mm, although other widths are possible.

Additionally, adjacent edge walls 30a, 30b of adjacent reactors 15a, 15b directly contact each other to form the array of reactors 15. According to an embodiment herein, the energy loss through the adjacent edge walls 30a, 30b is less than an energy loss through the end wall 25. Furthermore, the heat transfer between the adjacent reactors 15a, 15b is controlled by a temperature difference between the adjacent reactors 15a, 15b of the array of reactors 15. While not shown, the recirculating micro-combustor device 10 may further comprise a base and a cover. Eventually, the last set of reactors will have one terminating edge wall 30b that will interface with an insulating medium (not shown) or the environment, for example.

As shown in FIG. 2B, with reference to FIGS. 1 and 2A, another example of a device 10x is illustrated. In this example, the device 10x is similar to the device 10 shown in FIG. 2A except adjacent reactors 15a, 15b share an edge wall 30 to form the array of reactors 15. In this regard, rather than having two separate adjacent edge walls 30a (of FIG. 2A), there may be only one edge wall 30, and the two adjacent reactors 15a, 15b may share the second area 65x. Some adjacent reactors 15a, 15b may need to maintain the stiffness of the array 15 between the front wall 20 and end wall 25, but not all adjacent reactors 15a, 15b in a large array would be required to have separate adjacent edge walls 30a (of FIG. 2A). Thus, in a small array it may be possible to omit the adjacent edge wall 30a (of FIG. 2A) entirely.

Accordingly, FIG. 2B illustrates a catalytic or non-catalytic recirculating micro-combustor device 10x comprising an array of reactors 15 contacting each other. The device 10x comprises a front wall 20, an end wall 25 opposite to the front wall 20, an edge wall 30 positioned from the front wall 20 to the end wall 25, an inlet port 35 in the front wall 20, a plurality of outlet ports 40 in the front wall 20, and a combustion chamber 45 connected to the inlet port 35 and positioned between the front wall 20 and the end wall 25. The combustion chamber 45 comprises a pair of inner walls 50a, 50b defining a first area 55 to accommodate a chemical combustion 60 therein, and a plurality of second areas 65 to accommodate an exhaust 70 of a reaction of the chemical combustion 60. The plurality of second areas 65 connect to the plurality of outlet ports 40. The plurality of reactors 15a, 15b are arranged into an array of reactors 15 contacting each other. Moreover, adjacent reactors 15a, 15b share a second area 65x of the plurality of second areas 65.

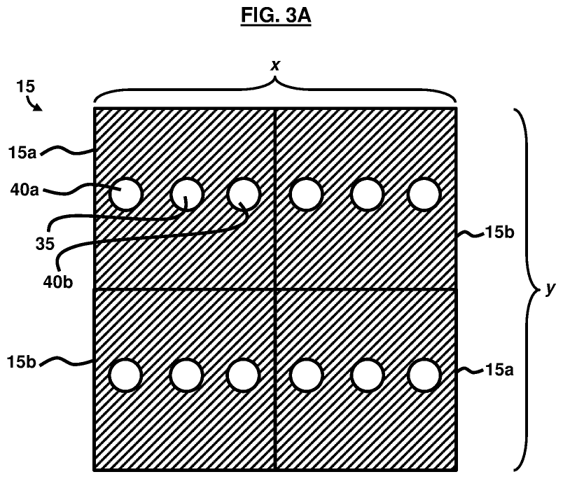

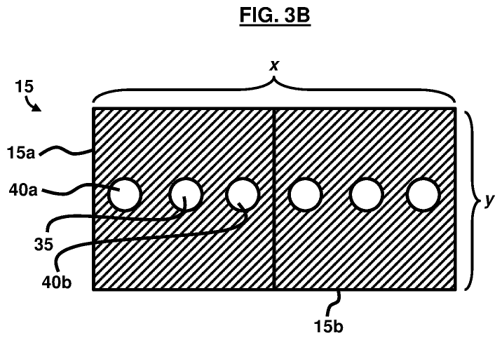

As shown in FIGS. 3A and 3B, with reference to FIGS. 1 through 2B, the array of reactors 15 comprises a x×y arrangement of rows and columns of the adjacent reactors 15a, 15b such that x and y are positive integers. In an example, x and y are equal as shown in FIG. 3A. As such, the array of reactors 15 may be arranged in a square configuration as shown in FIG. 3A. In another example, x and y are unequal as shown in FIG. 3B; i.e., in a rectangular configuration. Accordingly, x=y, x<y, or x>y.

To maximize thermal efficiency, the recirculating micro-combustor device 10 changes the desired energy extraction surface to the end cap (i.e., end wall 25) and identifies a means to insulate the pair of edge walls 30a, 30b, which would typically make up a significant portion of the heat lost in the conventional, non-array solutions. Accordingly, this is accomplished by arraying the individual reactors 15a, 15b next to and in contact with each another in order to minimize heat flow along outer walls (e.g., the pair of edge walls 30b) and creates an adiabatic boundary condition. Although energy is still lost via conduction along the length of the array of reactors 15 and on the periphery of the array of reactors 15, the fraction of energy lost through the outer walls (e.g., the pair of edge walls 30b) (Pathway (2)) falls with scaling (i.e., by approximately [n−1]/n, where n represents the number of reactors 15a, 15b on a side in a square configuration (as shown in FIG. 3A). For example, in the configuration of FIG. 3A, n=2. Moreover, the heat loss from the outer walls (e.g., the pair of edge walls 30b) is 50% lower when configured as an array of reactors 15 due to insulated inner walls (e.g., wall 30a).

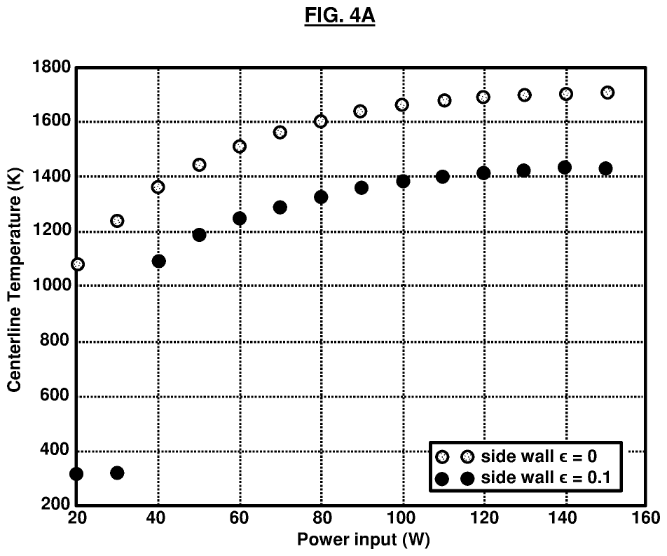

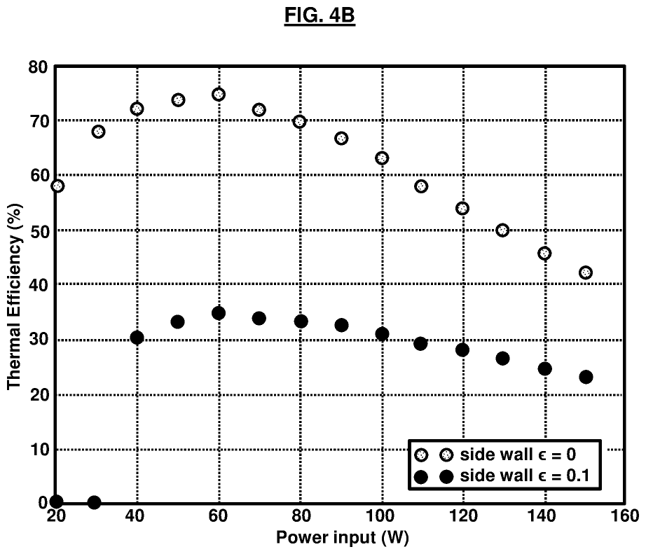

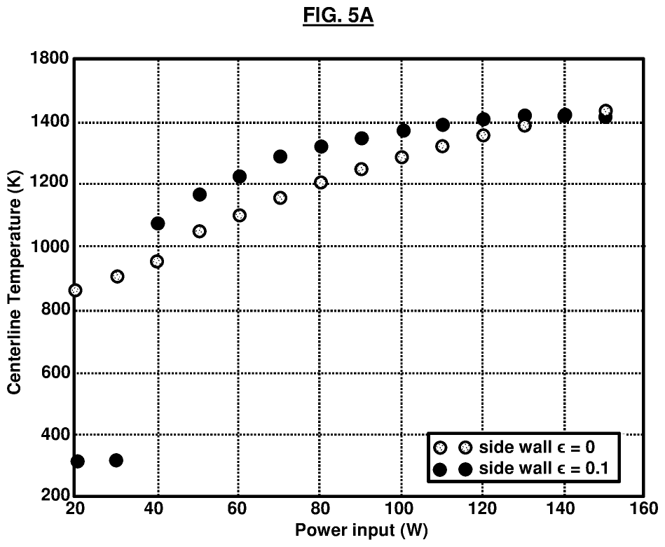

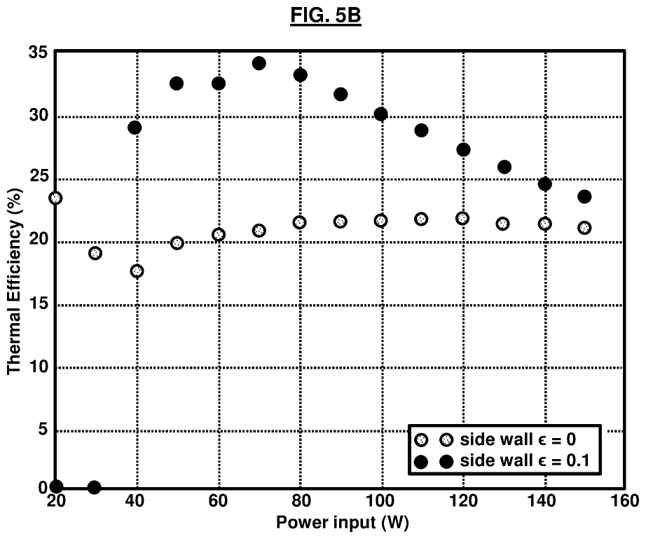

FIGS. 4A, 4B, 5A, and 5B, with reference to FIGS. 1 through 3B, compare end wall 25 temperatures and thermal efficiency for two cases as a function of input power. The first case assumes the outer reactor walls (e.g., walls 20, 25, 30b) are constructed using a low emissivity (0.1) highly polished metal surface. The second (limiting) case assumes no radiative losses from the periphery (e.g., walls 20, 25, 30b). For reference, a 9×9 (n=9) reactor array 15, would have an effective emissivity on the outer walls (e.g., walls 20, 25, 30b), assuming a highly polished metal surface (ε=0.1), of 0.01. Actual performance would fall between these two bounds.

Multiplexing alone does not result in higher thermal efficiencies as exhibited in FIG. 5B. In this case, intense preheating of reactants results in an earlier ignition event upstream from the target heat extraction surface. Higher temperatures require the use of alternative materials; e.g., silicon carbide or tungsten, etc., for the reactor 15 and for energy extraction, these results suppose a low work function thermionic material on the end wall 25. Moreover, the end wall 25 could just as well be a selective emitter for a thermophotovoltaic or a semiconductor for a thermoelectric application. In all three cases, the burner geometry and chemical power can be adjusted to achieve the temperature required for a particular application.

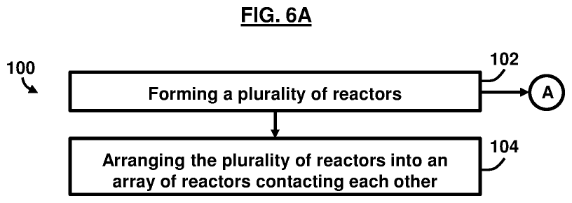

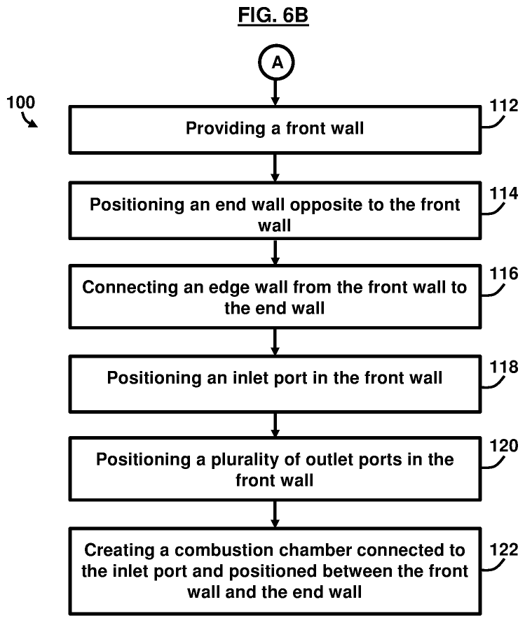

FIGS. 6A and 6B, with reference to FIGS. 1 through 5B, are flow diagrams illustrating a method 100 of forming a catalytic or non-catalytic recirculating micro-combustor device 10x, the method 100 comprising forming (102) a plurality of reactors 15a, 15b. According to an example, each reactor 15a, 15b is formed by providing (112) a front wall 20, positioning (114) an end wall 25 opposite to the front wall 20, connecting (116) an edge wall 30 from the front wall 20 to the end wall 25, positioning (118) an inlet port 35 in the front wall 20, positioning (120) a plurality of outlet ports 40 in the front wall 20, and creating (122) a combustion chamber 45 connected to the inlet port 35 and positioned between the front wall 20 and the end wall 25.

The combustion chamber 45 comprises a pair of inner walls 50a, 50b defining a first area 55 to accommodate a chemical combustion 60 therein, and a plurality of second areas 65 including a shared second area 65x to accommodate an exhaust 70 of a reaction of the chemical combustion 60. The plurality of second areas 65 connect to the plurality of outlet ports 40. The method 100 further comprises arranging (104) the plurality of reactors 15a, 15b into an array of reactors 15 contacting each other. Additionally, adjacent reactors 15a, 15b share a second area 65x of the plurality of second areas 65. The method 100 may further comprise extending the pair of inner walls 50a, 50b of the combustion chamber 45 from the front wall 20 in a cantilever configuration without contacting the end wall 25 thereby allowing the exhaust 70 to continue along the plurality of second areas 65 and out through the plurality of outlet ports 40.

According to an example, the array of reactors 15 is configured to have an energy loss through adjacent edge walls 30 to be less than an energy loss through the end wall 25. Furthermore, the first area 55 is configured to accommodate a mixture 75 of fuel and air through the inlet port 35 into the combustion chamber 45. The array of reactors 15 is configured to comprise a x×y arrangement of rows and columns of the adjacent reactors 15a, 15b such that x and y are positive integers. In this regard, the array of reactors 15 may be arranged in a square configuration. In an example, x and y are equal. In another example, x and y are unequal. Accordingly, x=y, x<y, or x>y. The array of reactors 15 is configured to have a heat transfer between the adjacent reactors 15a, 15b to be controlled by a temperature difference between the adjacent reactors 15a, 15b. According to an example, each reactor 15a, 15b may comprise any of silicon carbide, tungsten, a nickel-chromium-iron alloy, and ceramics. However, other materials such as high temperature metals, alloys, and superalloys may be utilized, and the embodiments herein are not restricted to a particular type of material. Moreover, the selection of the materials may be dependent on the temperatures resulting from the fuel and fuel flow rate, according to an example.

The manufacturability described by method 100 and the affordability of the recirculating micro-combustor device 10, 10x may depend on the materials selected for a given application and the desired production volume. For example, producing conventional a single-pixel microchannel reactor for laboratory experimentation is prohibitively expensive. Cost savings, however, would be immediately realized with greater volumes including using the configuration provided by the array of reactors 15 in the recirculating micro-combustor device 10, 10x. Additionally, alternative materials for nickel-chromium-iron alloys that can be shaped using additive techniques, which would shorten lead times and reduce the buy-to-fly ratio: two major factors that determine cost.

The embodiments herein provide an array of multiple reactors 15 in order to reduce heat loss in the system. The recirculating micro-combustor device 10, 10x provided by the embodiments herein reduces parasitic losses in a hydrocarbon-fueled heat source for use with a solid state electricity generator. This is accomplished by arraying a number of identical, highly heat recirculating concentric tube-in-tube reactors 15a, 15b next to and in contact with one another as an insulation strategy. Furthermore, experimental models suggest thermal efficiencies greater than 60% are possible even under extreme thermal loading. The electric energy that is produced by the recirculating micro-combustor device 10, 10x is dependent on the thermal losses due to the heat that is discharged by the exhaust 70 through the pair of outlet ports 40a, 40b (or plurality of outlet ports 40) as well as any thermal losses through the edge walls 30b (or edge wall 30). However, the thermal losses are minimized using the array configuration provided by the attached reactors 15a, 15b. The overall efficiency of the recirculating micro-combustor device 10, 10x depends upon the conversion of the thermal energy produced from the combustion reaction (e.g., in the combustion chamber 45) to the electric energy that is produced.

By coupling the array of reactors 15 to a suitable converter (e.g., such as thermoelectric, thermophotovoltaic, or thermionic), an entire class of silent, efficient, and portable power generators becomes possible. Accordingly, in additional to high theoretical thermal efficiencies, near limitless scaling is possible by utilizing the array of reactors 15 provided by the embodiments herein with the additional burners in the recirculating micro-combustor device 10, 10x. The embodiments herein may provide a technique to make chemical energy from a hydrocarbon fuel available as thermal energy on a desired surface. As such, there are several applications of the embodiments herein in thermal to electrical energy conversion systems, as well as any heating applications that may rely on the use of hydrocarbon fuels.

Moreover, there are several other applications afforded by utilizing the embodiments herein. For example, compact power sources, capable of storing and delivering large amounts of energy, are critical in numerous types of applications. Today, batteries are typically the only energy source used in several scenarios that can deliver power in the 10-100 Watt range. However, such power sources also represent a significant weight burden (up to 20% of a device/system). As such, a portable, efficient, hydrocarbon-fueled thermal-to-electrical energy convertor with even modest efficiencies (e.g., 15%) would significantly unburden the in-use application, especially for extended duration operation. Accordingly, the recirculating micro-combustor device 10 of the embodiments herein provides such a solution for these parameters.

Other applications for the recirculating micro-combustor device 10 include, for example, (1) primary and auxiliary power for campers, outdoorsmen, and recreational vehicles; (2) Auxiliary power for long-haul trucking cabin heaters; (3) Emergency generators at the point of need; (4) Field research where electronics require power for long durations in austere environments; and (5) If appropriately scaled, distributed electricity generation on the utility scale for home use; for example, combined heating and power from gas furnaces.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A recirculating micro-combustor device comprising:
an array of reactors contacting each other, wherein each reactor comprises:
a front wall;
an end wall oppositely positioned to the front wall;
a pair of edge walls connecting the front wall to the end wall;
an inlet port positioned in the front wall;
a pair of outlet ports positioned in the front wall; and
a combustion chamber connected to the inlet port and positioned between the front wall and the end wall, wherein the combustion chamber comprises a pair of inner walls defining a first area to accommodate a chemical combustion therein, and a pair of second areas to accommodate an exhaust of a reaction of the chemical combustion, and wherein the pair of second areas connect to the pair of outlet ports,
wherein adjacent edge walls of adjacent reactors directly contact each other to form the array of reactors.

2. The device of claim 1, wherein the pair of inner walls of the combustion chamber extend from the front wall in a cantilever configuration without contacting the end wall.

3. The device of claim 1, wherein an energy loss through the adjacent edge walls is less than an energy loss through the end wall.

4. The device of claim 1, wherein the first area is to accommodate a mixture of fuel and air through the inlet port into the combustion chamber.

5. The device of claim 1, wherein the array of reactors comprises a x×y arrangement of rows and columns of the adjacent reactors, and wherein x and y are positive integers.

6. The device of claim 5, wherein x and y are equal.

7. The device of claim 5, wherein x and y are unequal.

8. The device of claim 1, wherein the array of reactors is arranged in a square configuration.

9. The device of claim 1, wherein a heat transfer between the adjacent reactors is controlled by a temperature difference between the adjacent reactors.

10. The device of claim 1, wherein the reactor comprises any of silicon carbide, tungsten, and a nickel-chromium-iron alloy.

11. A method of forming a recirculating micro-combustor device, the method comprising:
forming a plurality of reactors, wherein each reactor is formed by:
providing a front wall;
positioning an end wall opposite to the front wall;
connecting an edge wall from the front wall to the end wall;
positioning an inlet port in the front wall;
positioning a plurality of outlet ports in the front wall; and
creating a combustion chamber connected to the inlet port and positioned between the front wall and the end wall, wherein the combustion chamber comprises a pair of inner walls defining a first area to accommodate a chemical combustion therein, and a plurality of second areas to accommodate an exhaust of a reaction of the chemical combustion, and wherein the plurality of second areas connect to the plurality of outlet ports;
arranging the plurality of reactors into an array of reactors contacting each other, wherein adjacent reactors share a second area of the plurality of second areas.

12. The method of claim 11, comprising extending the pair of inner walls of the combustion chamber from the front wall in a cantilever configuration without contacting the end wall.

13. The method of claim 11, wherein the array of reactors is configured to have an energy loss through adjacent edge walls to be less than an energy loss through the end wall.

14. The method of claim 11, wherein the first area is configured to accommodate a mixture of fuel and air through the inlet port into the combustion chamber.

15. The method of claim 11, wherein the array of reactors is configured to comprise a x×y arrangement of rows and columns of the adjacent reactors, and wherein x and y are positive integers.

16. The method of claim 15, wherein x and y are equal.

17. The method of claim 15, wherein x and y are unequal.

18. The method of claim 11, wherein the array of reactors is arranged in a square configuration.

19. The method of claim 11, wherein the array of reactors is configured to have a heat transfer between the adjacent reactors to be controlled by a temperature difference between the adjacent reactors.

20. The method of claim 11, wherein each reactor comprises any of silicon carbide, tungsten, and a nickel-chromium-iron alloy.
